(19) United States
(12) Patent Application Publication
(10) Pub. No.: US 2017/0291762 A1
(43) Pub. Date: Oct. 12, 2017

(54) WASTE DEPOSITION DEVICE FOR RIGHT AND LEFT HAND USE

(71) Applicant: GLOBAL MARK PLASTIC LIMITED, Kwun Tong (CN)

(72) Inventor: Kin Pong Eddy WONG, Kwun Tong (CN)

(21) Appl. No.: 15/358,036

(22) Filed: Nov. 21, 2016

(30) Foreign Application Priority Data
Apr. 11, 2016 (EP) 16164821
Sep. 29, 2016 (EP) 16191384

(51) Int. Cl. B65F 1/06; B65F 1/16; B65F 1/14

(52) U.S. Cl. CPC B65F 1/062; B65F 1/068; B65F 1/1415; B65F 1/1646

(57) ABSTRACT

The invention relates to a waste deposition device (1), comprising an annular holder (2) for a cassette (3) with a plastic hose (15). The waste deposition device (1) furthermore multiple mounting positions (A1 . . . A3) for arbitrarily and in particular removably mounting at least one tying and/or cutting device (4) for holding the hose (15) when knotting the same and/or for cutting the hose (15). Alternatively, multiple tying and/or devices (4) having said function may be permanent parts of the waste deposition device (1) at different positions (A1 . . . A3).

The invention relates to a waste deposition device, which comprises an annular holder for a cassette with a plastic hose.

A waste deposition device of the kind above is generally known and used for disposal of all kind of waste, particularly for disposal of baby and/or adult diaper and/or other personal waste material. For keeping unwanted smell inside the hose, the hose may be tied into a knot after disposal of waste. Furthermore, the hose may be cut with a blade.

In this context US 2013/0067857 A1 discloses a waste basket, comprising a holder with two slits and a blade arranged in one of the slits. The first slit it to hold a bag arranged in the basket. The second slit with the blade is to cut a plastic hose, into which waste is disposed.

GB 1 529 111 A discloses another waste deposition device with a blade for cutting a plastic hose.

As naturally tying a knot with just one hand is almost impossible to most users, prior art waste deposition devices force the users to tie the hose into a knot by use of both hands. Usually, this is no big problem, but when a user, for example, carries a crying baby on his arm, he cannot tie the hose at the same time what means that unwanted smell leaks from the waste deposition device for some time what is quite unpleasant to most users. This situation is even worse, as prior art systems do not take care of a special preference of the users with regards to the left or right hand. So even if the user is capable of tying a knot with just one hand, this might get an unsolvable challenge, if he carries the crying baby on his preferred arm and shall tie the knot with the “wrong” hand. Basically the same counts for cutting the hose.

Accordingly, a problem of the invention is to provide an improved waste deposition device. In particular, tying a knot into a plastic hose and/or cutting the same shall be possible with just one hand and/or the waste deposition device shall be designed for both right and left handers.

The problem of the invention is solved by a waste deposition device as defined in the opening paragraph, comprising

a) multiple mounting positions for arbitrarily and in particular removably mounting at least one tying device for holding the hose when knotting the same or at least one cutting device for cutting the hose or at least one combined tying/cutting device or

b) multiple tying devices for holding the hose when knotting the same, which are permanent parts of the waste deposition device, or multiple cutting devices for cutting the hose, which are permanent parts of the waste deposition device, or multiple combined tying/cutting devices, which are permanent parts of the waste deposition device.

In case b), the devices are arranged at different (mounting) positions of course.

By these measures, the waste deposition device may be used both by left hand users and right hand users in a comfortable way, independent of how and where the waste deposition device is arranged. The waste deposition device may comprise multiple mounting positions for arbitrarily and in particular removably mounting a tying device for holding the hose when knotting or tying the same (case a). In the same way, mounting positions may be used for arbitrarily and in particular removably mounting a cutting device for cutting the hose or a combined tying/cutting device. It should be noted, that also multiple tying and/or cutting devices can be mounted at the mounting positions, for example two tying and/or cutting devices can be mounted at two of three mounting positions. Alternatively, multiple tying and/or cutting devices having said function can be permanent parts of the waste deposition device.

It should also be noted that providing a tying device as such enables most users to knot the hose by use of just one hand in the first place respectively for the first time. As said above, tying a knot with just one hand is almost impossible to most users without additional help.

Further advantageous embodiments are disclosed in the claims and in the description as well as in the Figures.

Beneficially, the mounting positions respectively the tying and/or cutting devices are arranged at different angular positions around a center axis of the annular holder. In particular, the angles between said angular positions are substantially the same. Accordingly, the waste deposition device may be used both by left hand users and right hand users in a comfortable way. Moreover, the tying and/or cutting device is accessible even in case that the waste deposition device is placed in a corner or in a niche. The term “substantial” in the given context means that the difference between said angles is less than or equal to 10°.

In another beneficial embodiment, the waste deposition device comprises a lid, which is designed to open/close a center opening of the annular holder. Hence, smell is kept within the device even in case that the knot in the hose is not air-tight.

In the above context, beneficially a first mounting position respectively a first tying and/or cutting device is arranged vis-à-vis of a hinge of the lid and a second and a third mounting position respectively a second and a third tying and/or cutting device are arranged left and right thereof. These positions allow for comfortable use of the waste deposition device for most users.

It is particularly advantageous if the/each tying device comprises two pin-like portions with a slit in-between. By these measures, the hose may be knotted easily. To tie a knot, the hose is wound around the two pins and then threaded between said pins and through the generated loop. This movement may easily be performed by one hand. In contrast, one normally needs two free hands for tying or making a knot. So the waste deposition device for example allows for carrying a baby in one hand and for disposing a diaper and tie the plastic hose into a knot with the other hand.

It is advantageous if the distance between axes of the two pin-like portions increases towards the ends of the two pin-like portions and if an angle between said axes measured in the region of the two opening pin-like portions is equal to or less than 60°. That also means that the ends of the two pin-like portions point in basically the same direction (and not in opposed directions). By means of said measures, the loop of the hose is well held on the tying device during making the knot, and the knot in the hose can slipped off the tying device easily. The bigger the angle the lower is the risk that the knot slips off unintentionally. However, angles above 60° may cause catching the knot on the tying device.

It is also advantageous if the axes of the two pin-like portions are substantially parallel and if the ends of the two pin-like portions point in basically the same direction (and not in opposed directions). “Substantially parallel” in this context in particular means that an angle between the axes of the two pin-like portions is equal to or less than 10°. In other words, the distance between axes of the two pin-like portions does not substantially increase towards the ends of the two pin-like portions, and an angle between said axes measured in the region of the two opening pin-like portions is equal to or less than 10°. For this reason, the knot in the hose can slipped off the tying device even more easily.

Advantageously, the slit is V-shaped and opens towards the ends of the two pin-like portions. For this reason, the hose may be thread through the loop easily. However, the slit may also be bordered by parallel walls.

In the above context, advantageously a blade is arranged in the/each slit. Hence, the hose may be cut easily. Because of the blade, a combined tying/cutting device is provided.

In yet another advantageous embodiment, a stopper is arranged at a distance from the free end of the pin-like portions. Particularly, the stopper is arranged at the end of the slit or before the end of the slit. By these measures, an undesired slipping of the hose into an unslit portion of the tying device what would hinder guiding the hose between the pins and through the loop of the hose, is avoided.

In yet another advantageous embodiment, a depression is arranged on and running along the pin-like portions. In this way, the one making the knot can even more easily put a finger, in particular his thumb, through the loop formed by the hose wound around the two pins. Accordingly, it is even more easy to finish the knot by threading the free end of the hose through the loop.

Beneficially, an outer circumference of the waste deposition device in a cross section across said annular holder and perpendicular to the center axis of the annular holder is substantially rectangular. Hence, the waste deposition device can be placed in a corner or in a niche in a space-saving way. Anyway, said cross section may also be circular or oval.

In a beneficial embodiment, the waste deposition device comprises a post protruding from the base, the annular holder mounted to the post and the tying device(s) mounted to the annular holder. Thus, the waste deposition device may be used as a stand-alone device. Alternatively, or in addition, the waste deposition device may comprise a device holder or device holders for mounting the waste deposition device on other structures, for example on the frame of a crib or on other furnishing.

In a further beneficial embodiment, the waste deposition device comprises a box arranged below the annular holder. Thus, waste in the hose is stored in a dedicated space.

Advantageously, the cassette with the plastic hose is rotatable around the center axis of the annular holder and in relation to the mounting positions respectively the tying and/or cutting devices. In this way, the hose may be twisted after disposal of waste in an easy way.

Further advantageously, the waste deposition device comprises a gear coupled to the lid and to the annular holder or the cassette. In this way, the cassette is rotated and the hose is twisted automatically when the lid is opened and/or closed.

For better understanding the invention, Figures showing embodiments of the invention are presented hereinafter. The Figures schematically show:

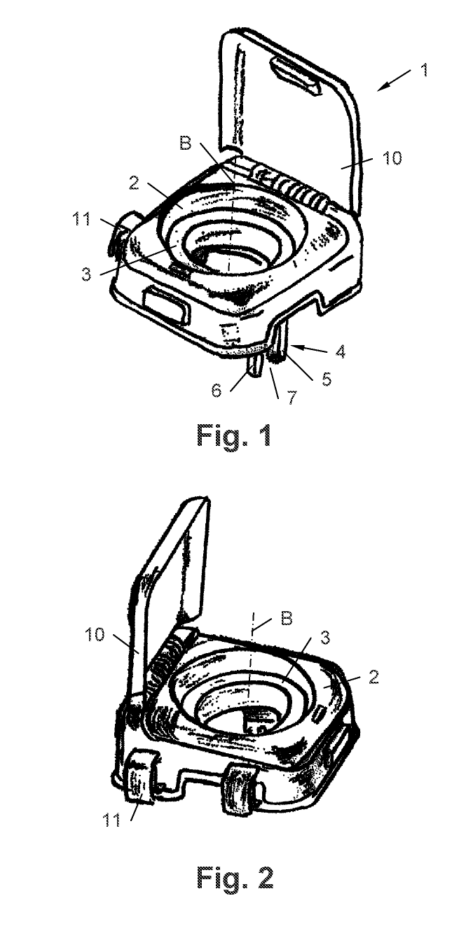

FIG. 1 an oblique view of an exemplary waste deposition device from the right front side;

FIG. 2 the waste deposition device of FIG. 1 from the left front side;

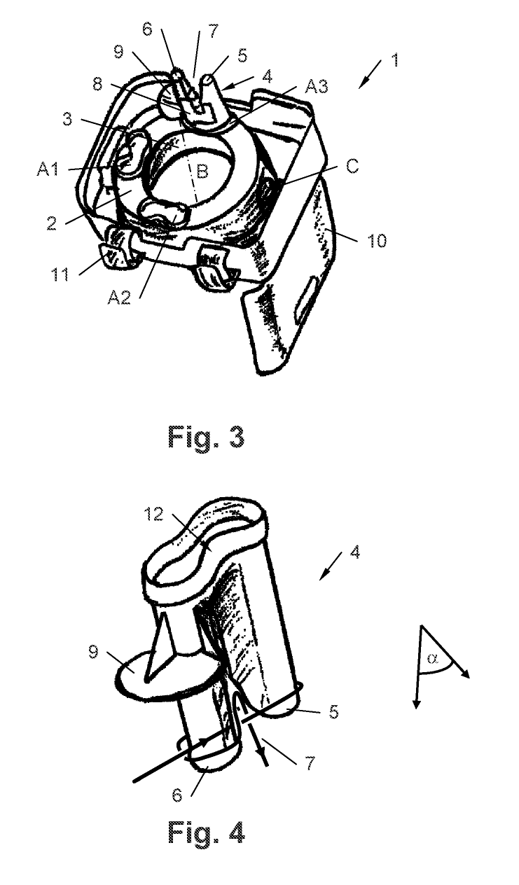

FIG. 3 the waste deposition device of FIG. 1 from the bottom side;

FIG. 4 a detailed oblique view of an exemplary tying device from the top side;

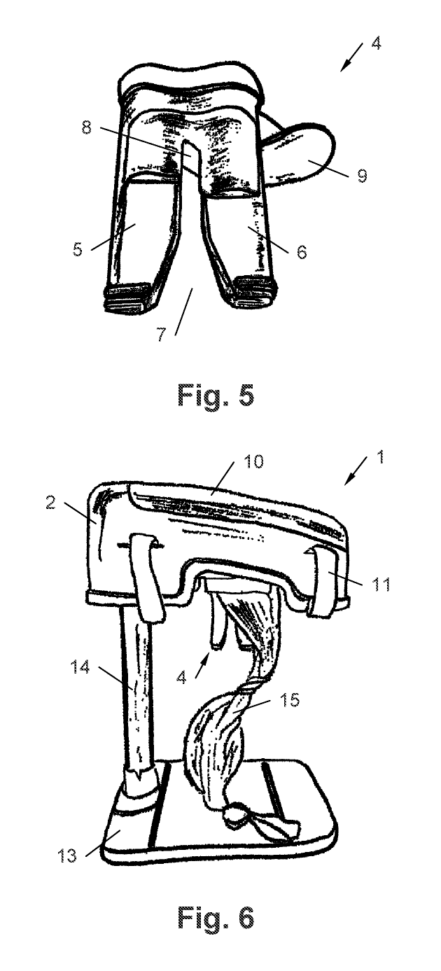

FIG. 5 a front view of the tying device of FIG. 4 and

FIG. 6 a side view of an exemplary waste deposition device with a base and a post.

Generally, same parts or similar parts are denoted with the same/similar names and reference signs. The features disclosed in the description apply to parts with the same/similar names respectively reference signs. Indicating the orientation and relative position (up, down, sideward, etc.) is related to the associated Figure, and indication of the orientation and/or relative position has to be amended in different Figures accordingly as the case may be.

FIGS. 1 to 3 show a waste deposition device 1 in different views. FIG. 1 shows an oblique view from the right front side, FIG. 2 from the left front side and FIG. 3 from the bottom side. The waste deposition device 1, comprises an annular holder 2 for a cassette 3 with a plastic hose and a combined tying/cutting device 4 for holding the hose when knotting the same.

FIGS. 4 to 5 show the tying/cutting device 4 in detail. FIG. 4 shows an oblique view from the top side, and FIG. 5 shows a front view. The tying/cutting device 4 comprises two pin-like portions 5, 6 with a slit 7 in-between. By these measures, the hose may be tied into a knot easily. For that reason, the hose is wound around the two pins 5, 6 and then threaded between said pins 5, 6 and through the generated loop of the hose (see the movement path shown in FIG. 4). The final downward movement does not just finish the knot but also slips the finished knot off the tying/cutting device 4.

This movement may easily be performed by one hand. In contrast, one normally needs two free hands for tying a knot. So the waste deposition device 1 for example allows for carrying a baby in one hand and for disposing a diaper and tying the plastic hose into a knot with the other hand. Of course, the movement path starting on the left side as shown in FIG. 4 is just exemplary, and the movement can also start from other directions, for example from the front side, from the right side, from the back side or from another direction in-between.

In the example shown in the Figures, the axes of the two pin-like portions 5, 6 are substantially parallel and the ends of the two pin-like portions 5, 6 point in basically the same direction (and not in opposed directions). In FIG. 4 both ends point downwards (and not downwards and upwards). “Substantially parallel” in this context in particular means that an angle a between the axes of the two pin-like portions is equal to or less than 10°. For this reason, the loop for the knot is well held on the tying/cutting device 4 during making the knot, and the knot in the hose can slipped off the tying/cutting device 4 very easily. However, the angle a between the axes of the two pin-like portions 5, 6 may be up to 60° (see also the stylized two pin-like portions 5, 6 shown as “vectors” in the right region of FIG. 4). If so, the loop of the hose is better held on the tying/cutting device 4 during making the knot. The bigger the angle the lower is the risk that the knot slips off the tying/cutting device 4 unintentionally. However, angles above 60° may cause catching the knot on the tying/cutting device 4. In this example, the slit 7 is V-shaped and opens towards the ends of the two pin-like portions 5, 6. For this reason the hose may be thread through the loop easily. However, the slit 7 may also be bordered by parallel walls.

Moreover, the tying/cutting device 4 comprises a blade 8 arranged in the slit 7 in this example. In this case, the plastic hose may be cut easily. Furthermore, the tying/cutting device 4 may comprise an optional stopper 9 arranged at a distance from the free end of the pins 5, 6. Particularly, the stopper 9 is arranged at the end of the slit 7 or before the end of the slit 7. By these measures, an undesired slipping of the plastic hose into an unslit portion of the tying/cutting device 4 when wounding the plastic hose around the pins 5, 6, in particular during an upward movement, is avoided. Such an undesired slipping would hinder guiding the hose between the pins 5, 6 and through the loop of the hose. Of course, stoppers 9 may be arranged on both pin-like portions 5, 6.

In the example shown in the Figs., the tying/cutting device 4 comprises a depression 12 arranged on and running along the pin-like portions 5, 6. By these measures, one making the knot can even more easily put a finger, in particular his thumb, through the loop formed plastic hose wound around the two pins 5, 6. Accordingly, it is even more easy to finish the knot by threading the free end of the plastic hose through the loop.

One should note that the blade 8 is optional. If there is no blade 8, the device 4 shown in the Figures is just a tying device. On the other hand, if there is just the blade 8 and there are no means for tying, the device 4 is just a cutting device. Of course, the waste deposition device 1 may comprise any number of separate tying devices and cutting devices for providing a tying function and cutting function.

The technical teaching related to the Figures equally applies to tying devices, cutting devices and combined tying/cutting devices 4, except of features just related to tying or cutting. Thus, in particular the disclosure related to the mounting positions A1 . . . A3 below equally applies to tying devices, cutting devices and combined tying/cutting devices 4.

In the example shown in FIGS. 1 to 3, the waste deposition device 1 comprises multiple mounting positions A1 . . . A3 for arbitrarily and in particular removably mounting the tying/cutting device 4 (case a). It should be noted, that also multiple tying/cutting devices 4 can be mounted at the mounting positions A1 . . . A3, for example two tying/cutting devices 4 can be mounted at two of three mounting positions A1 . . . A3. Alternatively, multiple tying/cutting devices 4 for holding the hose when knotting the same and for cutting the same can be permanent parts of the waste deposition device 1.

In the example shown in FIGS. 1 to 3, the mounting positions A1 . . . A3 are arranged at different angular positions around a center axis B of the annular holder 2. Concretely, a first mounting position A1 is arranged vis-à-vis of a hinge of an optional lid 10, which is designed to open/close a center opening of the annular holder 2 and to keep smell inside of the waste deposition device 1 respectively within the plastic hose even in case that the knot in the hose is not air-tight. A second and a third mounting position A2, A3 are arranged left and right thereof. Accordingly, the waste deposition device 1 may be used both by left hand users and right hand users in a comfortable way. Moreover, the tying/cutting device 4 is accessible even in case that the waste deposition device 1 is placed in a corner or in a niche.

In addition, the waste deposition device 1 comprises a mounting position C for a post (see also FIG. 6).

Moreover, the waste storage device 1 comprises an optional device holder 11 or optional device holders 11 for mounting the waste storage device 1 on other structures, for example on the frame of a crib or on other furnishing.

In the above embodiment, the angles between said angular positions are different. However, in an alternative embodiment, the angles between said angular positions may substantially be the same. The term “substantial” in the given context means that the difference between said angles is less than or equal to 10°.

It is also beneficial, if an outer circumference of the waste deposition device 1 in a cross section across said annular holder 2 and perpendicular to the center axis B of the annular holder 2 is substantially rectangular as this is the case for the embodiment shown in FIGS. 1 to 3. Hence, the waste deposition device 1 can be placed in a corner or in a niche in a space-saving way. However, said cross section may also be oval or circular in an alternative embodiment. It should also be noted that although the cartridge 3 is circular in the shown example, the cartridge 3 may also be oval.

FIG. 6 shows an exemplary embodiment of a waste deposition device 1 with the tying/cutting device 4 being mounted to the annular holder 2 at the third mounting position A3. The waste deposition device 1 moreover comprises a base 13 and a post 14 protruding from the base 13. The annular holder 2 is mounted to the post 14 at the mounting position C. Thus, the waste deposition device 1 may be used as a stand-alone device. Alternatively or in addition, the waste deposition device 1 may also comprise an optional device holder 11 or optional device holders 11 for mounting the waste deposition device 1 on other structures, for example on the frame of a crib or on other furnishing. Further alternatively, the waste deposition device 1 may comprise a box arranged below the annular holder 2. Thus, waste in the hose is stored in a dedicated space. In FIG. 6 there is also a plastic hose 15 in the cassette 3 so that the waste deposition device 1 is ready to use.

Generally, the cassette 3 and/or the annular holder 2 may be designed to rotate around the center axis B of the annular holder 2 and in relation to the mounting positions A1 . . . A3 respectively tying/cutting devices 4. In this way, the plastic hose 15 may be twisted after disposal of waste in an easy way. In this context, the waste deposition device 1 may also comprise a gear coupled to the lid 10 and to the annular holder 2 or the cassette 3 so that the cassette 3 is rotated and the hose 15 is twisted automatically when the lid 10 is opened and/or closed.

Generally, the tying/cutting device 4 may be mounted to the annular holder 2 by means of a snap fit connection or a frictional connection, when it is designed to be removable. However, the tying/cutting device 4 may also be permanently mounted to the annular holder 2 by means of an adhesive, for example. The same counts for the post 14, which may be mounted to the annular holder 2 by means of a snap fit connection, a frictional connection or by means of an adhesive. Generally, the mounting positions A1 . . . A3 and C may also be termed “receiving positions”.

It is noted that the invention is not limited to the embodiments disclosed hereinbefore, but combinations of the different variants are possible. In reality, the waste deposition device 1 may have more or less parts than shown in the Figures. The waste deposition device 1 and parts thereof may also be shown in different scales and may be bigger or smaller than depicted. Finally, the description may comprise subject matter of further independent inventions.

### LIST OF REFERENCE NUMERALS

1 waste deposition device

2 annular holder

3 cassette

4 tying/cutting device

5 first pin-like portion

6 second pin-like portion

7 slit

8 blade

9 stopper

10 lid

11 device holder

12 depression

13 base

14 post

15 plastic hose

A1 . . . A3 mounting positions for tying and/or cutting device

B center axis of annular holder

C mounting position for a post

1. Waste deposition device, comprising an annular holder for a cassette with a plastic hose, for then comprising:
a) multiple mounting positions for arbitrarily mounting at least one tying device for holding the hose when knotting the same or at least one cutting device for cutting the hose or at least one combined tying/cutting device or
b) multiple tying devices for holding the hose when knotting the same, which are permanent parts of the waste deposition device, or multiple cutting devices for cutting the hose, which are permanent parts of the waste deposition device, or at least one combined tying/cutting devices, which are permanent parts of the waste deposition device.

2. Waste deposition device as claimed in claim 1, wherein the mounting positions respectively of the tying and/or cutting devices are arranged at different angular positions around a center axis of the annular holder.

3. Waste deposition device as claimed in claim 2, wherein angles between said angular positions are substantially the same.

4. Waste deposition device as claimed in claim 1, comprising a lid, which is designed to open/close a center opening of the annular holder.

5. Waste deposition device as claimed in claim 4, wherein a first mounting position respectively of a first tying and/or cutting device is arranged with of a hinge of the lid and a second and a third position respectively of a second and a third tying and/or cutting device are arranged left and right thereof.

6. Waste deposition device as claimed in claim 1, wherein the/each tying and/or cutting devices comprises two pin-like portions with a slit in-between.

7. Waste deposition device as claimed in claim 6, wherein a distance between axes of the two pin-like portions increases towards the ends of the two pin-like portions and an angle (α) between said axes measured in the region of the two opening pin-like portions is equal to or less than 60°.

8. Waste deposition device as claimed in claim 7, wherein the axes of the two pin-like portions are substantially parallel, and wherein the ends of the two pin-like portions point in basically the same direction.

9. Waste deposition device as claimed in claim 6, comprising that the slit is V-shaped and opens towards the ends of the two pin-like portions.

10. Waste deposition device as claimed in claim 6, wherein a blade is arranged in the/each slit.

11. Waste deposition device as claimed in claim 6, comprising a stopper arranged at a distance from the free end of the pin-like portions.

12. Waste deposition device as claimed in claim 6, comprising a depression arranged on and running along the pin-like portions.

13. Waste deposition device as claimed claim 1, comprising a base, a post protruding from the base, the annular holder mounted to the post at a mounting position and the tying and/or cutting device(s) mounted to the annular holder.

14. Waste deposition device as claimed in claim 1, comprising a box arranged below the annular holder.

15. Waste deposition device as claimed in claim 1, wherein the cassette is rotatable around the center axis of the annular holder and in relation to the mounting positions respectively of the tying and/or cutting devices.

16. Waste deposition device as claimed in claim 15, comprising a gear coupled to the lid and to the annular holder or the cassette.
